(19) United States
(12) Patent Application Publication
(10) Pub. No.: US 2025/0001632 A1
(43) Pub. Date: Jan. 2, 2025

(54) SYSTEM COMPRISING A PERSONAL CARE DEVICE SUCH AS ELECTRIC SHAVER AND HANGER FOR SUCH DEVICE

(71) Applicant: Braun GmbH, Kronberg (DE)

(72) Inventors: Gerd LASCHINSKI, Bad Homburg (DE); Markus SCHUESSLER, Koenigstein (DE); Philipp GOEDER, Frankfurt (DE); Ruediger BOSS, Frankfurt (DE); Sebastian HEINRICH, Bartholomae (DE)

(21) Appl. No.: 18/757,038

(22) Filed: Jun. 27, 2024

(30) Foreign Application Priority Data
Jun. 30, 2023 (EP) 23182805.4

(51) Int. Cl. B26B 19/38

(52) U.S. Cl. CPC B26B 19/3833; B26B 19/3813; B26B 19/3866; B26B 19/3873

(57) ABSTRACT

The present invention relates to a system comprising personal care device and a shower hanger, wherein a power socket for receiving an electric power supply plug is provided at said housing. The present invention further relates to a hanger for hanging up said personal care device, said hanger comprising a plug to be inserted into the power socket of said personal care device. It is suggested to provide for matching snap-fit contours at the power socket of the personal care device on the one hand and the hanger on the other hand to allow for attaching the hanger to the personal care device by means of snap-fitting the hanger in the power socket of the personal care device.

### FIELD OF THE INVENTION

The present invention relates to a system comprising a hanger and a personal care device, in particular an electric hair removal device such as a shaver or trimmer, comprising an elongated housing receiving an electric motor and/or an electric power source, a working head attached to said housing, wherein a power socket for receiving an electric power supply plug is provided at said housing. The present invention further relates to a hanger for hanging up said personal care device, said hanger comprising a plug to be inserted into the power socket of said personal care device, and to a system comprising the personal care device and said hanger.

### BACKGROUND OF THE INVENTION

Electric shavers and other hair removal devices such as epilators or beard trimmers usually have one or more cutter elements driven by an electric drive unit in an oscillating or rotatory continuous manner where the cutter elements may cooperate with a perforated shear foil or a comb-like cutter bar or other co-operative counter-elements, depending on the type of cutting. Said electric drive unit may include an electric motor or a magnetic-type linear motor, wherein the drive unit may include a drive train having elements such as an elongated drive transmitter for transmitting the driving motion of the motor to the cutter element, wherein said motor may be received within the handle portion of the shaver. Electric power for charging a battery or directly powering the drive may be supplied via a power socket at the housing to which a power cable can be connected.

When accommodating the motor in the handle, a seal for sealing the housing should prevent liquids or moisture from entering into the housing and damaging the electric internal components, wherein such sealing should be effective particularly at the interface between the housing and the working head, and at the power socket where the power connector's terminals connected to the power source inside the housing extend through said housing to be accessible from the exterior. Such power source may be an electric power storage such as a battery or an accumulator for supplying electric power to the motor and/or electronics.

Prior art document U.S. Pat. No. 2,962,197 B1 suggests use of the power socket for attaching a safety strap. More particularly, a loop-shaped, flexible strap is provided with a flattened attachment portion that can be fitted into the plug socket, wherein the flattened portion has two openings to receive the prongs or connector pins in the plug socket. So as to fix the flattened portion of the safety strip in said plug socket, the electric power plug of the electric supply cable is inserted into the plug socket to hold down the section of the flattened portion having the two openings fitted onto the connector pins and, furthermore, to sort of clamp the flattened portion between the walls of the plug socket and the power plug. Such clamping of the safety strap, however, requires some gap or at least play between the plug socket and the power plug and, furthermore, restricts the design freedom with regard to shape and fit of the plug socket and the power plug. Aside from that, the strap cannot be used without the electric cable plugged into the shaver's housing so it may not be used for hanging up the shaver without the electric cable in, for example, shower cabins.

Prior Art document U.S. Pat. No. 7,698,823 B1 discloses a manual, non-powered, wet razor, showing various embodiments of connecting the razor with a wrist strap. One of the embodiments shows a wrist strap having an attachment plug being inserted into a back end opening of the razor by a snap fit connection.

### SUMMARY OF THE INVENTION

It is an objective underlying the present invention to provide for an improved system of personal care device such as an electric shaver or trimmer and a hanger avoiding at least one of the disadvantages of the prior art and/or further developing the existing solutions.

A more particular objective underlying the invention is to provide for convenient storage of the personal are device in a shower cabin or other bathroom spaces allowing for easy handling without requiring specific storage installations such as storage dishes.

A further objective underlying the invention is to provide for an improved personal care device and a hanger for such device or system that can be easily attached and taken off, but nevertheless reliably holds the personal care device when hanging it up in wet environments such as in shower cabins.

More particularly, an objective underlying the present invention is to a allow releasable attachment of the hanger to personal care devices having a sealed container housing for accommodating electric components such as an electric motor and/or an electric power source, wherein the sealing is providing for sufficient protection against liquids and/or moisture and the hanger does not jeopardize such sealing.

At least one of the above objectives is addressed by a system having the features of claim 1. At least one of the above objectives is also addressed by a hanger having the features of claim 6. Advantageous further embodiments are set forth by the dependent claims 2-5 and 7-16.

To achieve at least one of the aforementioned objectives, it is suggested to provide for matching snap-fit contours at the power socket of the personal care device on the one hand and the hanger on the other hand to allow for attaching the hanger to the personal care device by means of snap-fitting the hanger in the power socket of the personal care device. Such snap-fit contours allow for reliably attaching the hanger to the personal care device even in wet environments and prevent the hanger from unintentional removal due to, for example, vibrations or shock-like pulling forces. Contrary to, for example, suction cups, the snap-fit contours do not decouple when getting wet. In addition, the hanger may be self-locking in the power socket without need of additional elements (the snap fit elements are not considered as additional elements), in particular the personal care device may be hung up without inserting the power supply cable into the power socket. The hanger has the same matching contour as that of the power plug within the power socket of the device with the addition of a snap fit connection between the power socket and the hanger, which snap fit connection is not provided with the power plug being connected with the device as the power plug is missing a corresponding snap fit hook to connect with an undercut in the socket.

The hanger is made of two different materials preferably having two different hardness and/or flexibility properties. The hanger comprises a soft portion and a hard portion, which both are be made from plastic material. More particularly, the hanger body which forms a loop or a sling or an eyelet and/or may form a gripping portion of the hanger may be made from soft plastic material or rubber-like material, whereas the hanger's plug to be inserted into the power socket of the personal care device is formed from hard material, in particular hard plastic material. This allows on the one side for optimized long life functionality of the snap fit connection and on the side for easy hanging properties and comfortable handling of the loop portion of the hanger.

When considering the plugging-in process including inserting the plug into the plug socket along an insertion axis which is usually defined by the co-axially arranged longitudinal axes of the socket and the plug, such matching snap-fit contours may include snap-fit undercuts which may form a step-like edge or a recess or a widening that extends transverse to said insertion axis in, for example, a side wall or peripheral wall of the plug socket or the plug to allow locking of a projection transverse to the axis of insertion at such step-like edge or recess or, more generally, holding the projecting contour in the recess contour due to form-fit therebetween against pulling back or sliding of the plug out of the plug socket along the insertion axis.

For example, the inner side walls of the plug socket may be provided with a recess or an end portion forming an undercut into which a projecting locking contour on a circumferential side of the plug may enter to lock the plug in the plug socket due to form-fit between such undercut and the matching projection. The opposite pairing of contours is possible, and the hanger's plug may be provided with an undercut formed by, for example, a recess in a circumferential side wall of the plug, and the plug socket may be provided with a projection positioned and contoured to fit into such recess to get locked at said undercut to prevent the plug from being pulled out of the socket.

At least one of said snap-fit contours may be flexible or flexibly supported to allow displacement of the snap-fit contour transverse to the insertion axis so as to allow coupling and/or decoupling of the matching contours. More particularly, at least one of said snap-fit contours such as the snap-fit undercut or the snap fit projection may flex inwardly or outwardly when inserting the plug into the socket, wherein a ramp-like or wedge like contour neighboring the undercut or the projection may cause transverse flex of the element having the projection or the element having the undercut when sliding along such ramp or wedge contour due to insertion. When reaching the matching position, said flexing element may flex to engage the latching contours.

While the snap-fit contours may flex transversely, it may be also held fixedly or non-displaceable in the direction of the insertion axis or the longitudinal axes of the plug and the socket to achieve stable attachment of the hanger in the power socket substantially without play.

According to a further aspect, the hanger may include a soft portion and a hard portion, which both may be made from plastic material. More particularly, the hanger body which may form a loop or a sling or an eyelet and/or may form a gripping portion of the hanger may be made from soft plastic material or rubber-like material, whereas the hanger's plug to be inserted into the power socket of the personal care device may be formed from hard material, in particular hard plastic material. For example, the hanger may be made in one piece by means of a two-component injection molding process. In the alternative, the plug may be assembled from at least two parts that were manufactured separately. Further alternatively both is combined, i.e. the hanger comprises a two-component injection molded hard-soft part and an additional, preferably hard plastic part assembled on or at the hard plastic (plug) portion of the hard-soft part.

According to a still further aspect, the hanger may be configured to completely close or completely cover the power socket in the housing of the personal care device to help in water-resistance of the personal care device. The hanger's attachment plug may be provided with collar-like rim extending beyond the opening edge of the power socket to cover the power socket like an umbrella. In addition, or in the alternative, the hanger's attachment plug may be provided with a sealing layer or a sealing element such as a sealing ring snuggly fitting onto the surface of the power socket and/or the housing of the personal care device to achieve sealing of the power socket vs. the ambience.

These and other advantages become more apparent from the following description giving reference to the drawings and possible examples.

### BRIEF DESCRIPTION OF THE DRAWINGS

FIG. 1: a perspective view of an electric hair removal device and a hanger for hanging up such hair removal device before attaching the hanger to the device,

FIG. 2: a perspective view of the electric hair removal device with the hanger attached to the housing and inserted into the device's electric power socket,

FIG. 3: a perspective side view of the personal care device with the hanger attached thereto when hanging the device up at a wall hook,

FIG. 4: a perspective view of the hanger illustrating the attachment plug and the loop-shaped hanger body attached thereto,

FIG. 5: a perspective exploded view of the hanger comprising hard and soft components including a hard plastic plug part, a hard plastic connection part and a soft plastic hanger body,

FIG. 6: a cross-sectional view of the hanger's attachment plug illustrating the flexible snap-fit arm having a hook-shaped latching contour,

FIG. 7: a cross-sectional view of the hanger's attachment plug similar to FIG. 6, wherein the flexible snap-fit arm is additionally flexibly supported by means of a spring device,

FIG. 8: a cross-sectional view of the hanger snap-fitted into the power socket of the hair removal device of FIGS. 1 to 3, wherein a push button for releasing the snap-fit is highlighted,

FIG. 9: a partial cross-sectional view of the hanger's attachment plug snap-fitted into the power socket of the hair removal device,

FIG. 10: a cross-sectional view of the hanger's attachment plug and the hair removal device's power socket after removal of the hanger,

FIG. 11: an enlarged partial cross-sectional view of the snap-fitting contours of the hanger's attachment plug locked in the power socket,

FIG. 12: a perspective view of the hanger illustrating a drainage hole in the attachment plug to drain water in the power socket via the hanger's attachment plug,

FIG. 13: a perspective view into the power socket illustrating the connector pins of the power socket, and

FIG. 14: a partial cross-sectional view of metal sleeves of the attachment hanger snap-fitted onto the connector pins of the power socket.

### DETAILED DESCRIPTION OF THE INVENTION

According to an aspect, to achieve at least one of the aforementioned objectives, it is suggested to provide for matching snap-fit contours at the power socket of the personal care device on the one hand and the hanger on the other hand to allow for attaching the hanger to the personal care device by means of snap-fitting the hanger in the power socket of the personal care device.

Such snap-fit contours allow for reliably attaching the hanger to the personal care device even in wet environments and prevent the hanger from unintentional removal due to, for example, vibrations or shock-like pulling forces. Contrary to, for example, suction cups which tend to slip or completely peel away when subject to moisture, the snap-fit contours do not decouple when getting wet. In addition, the hanger may be self-locking in the power socket without need of additional elements, in particular the personal care device may be hung up without inserting the power supply cable into the power socket.

The attachment plug may be occupying the substantially entire cross-sectional area of the power socket when inserted into said power socket. The attachment plug may be seated in the power socket under a slight press-fit to prevent tottering and to be suggestive of a well-fitting attachment of the hanger to the handle of the device.

When considering insertion of the plug into the plug socket along an insertion axis which is usually defined by the co-axially arranged longitudinal axes of the socket and the plug, such matching snap-fit contours may include snap-fit undercuts which may form a step-like edge or a recess or a widening transverse to said insertion axis in, for example, a side wall or peripheral wall of the plug socket or the plug to allow locking of a projection transverse to the axis of insertion at such step-like edge or recess or, more generally, holding the projecting contour in the recess contour due to form-fit therebetween against pulling back or sliding of the plug out of the plug socket along the insertion axis.

For example, the inner side walls of the plug socket may be provided with a recess or an end portion forming an undercut into which a projecting locking contour on a circumferential side of the plug may enter to lock the plug in the plug socket due to form-fit between such undercut and the matching projection. The opposite pairing of contours is possible, and the hanger's plug may be provided with an undercut formed by, for example, a recess in a circumferential side wall of the plug, and the plug socket may be provided with a projection positioned and contoured to fit into such recess to get locked at said undercut to prevent the plug from being pulled out of the socket.

At least one of said snap-fit contours may be flexible or flexibly supported to allow displacement of the snap-fit contour transverse to the insertion axis so as to allow coupling and/or decoupling of the matching contours. While the plugging movement goes along the inserting axis or along the longitudinal axes of the plug and the socket, the coupling and decoupling movement of the snap-fit contours may go transverse thereto. In particular, the coupling and decoupling movement of the snap-fit contours may go in radial direction and/or outwardly/inwardly relative to the central longitudinal axes of the plug and the socket. However, the coupling and decoupling movement of the snap-fit contours may go circumferentially or tangential thereto.

More particularly, at least one of said snap-fit contours such as the snap-fit undercut or the snap fit projection may flex inwardly or outwardly when inserting the plug into the socket, wherein a ramp-like or wedge like contour neighboring the undercut or the projection may cause transverse flex of the element having the projection or the element having the undercut when sliding along such ramp or wedge contour due to insertion. When reaching the matching position, said flexing element may flex to engage the latching contours.

The snap-fit contour of the hanger and/or the snap-fit contour of the power socket of the personal care device may be provided on a flexible or flexibly supported carrier element which is flexibly displaceable in a direction transverse to the axis of insertion of the attachment plug of the hanger into the power socket of the personal care device. Such carrier element may flex when inserting the attachment plug into the socket and/or when removing the attachment plug from the socket to allow the snap-fit contour to pass contours neighboring the undercut or projection on the other element, in particular to allow sliding of the snap-fit contour along tighter portions of the socket or wider portions of the plug, or may allow disengaging the snap-fit contours from each other.

Such carrier element may include a support finger extending substantially along an outer side of the plug or the inner side of the socket, in particular substantially parallel to the longitudinal axis thereof, and may be separated from neighboring portions of the respective side wall by a u-shaped slot for example so the support finger may form a sort of cantilevered bending beam. Due to flexibility, such support finger may be bent to thereby allow displacement of the snap-fir contour attached to an end portion said support arm or support finger into the transverse direction. In the alternative, the support finger may be pivotably supported by a pivot joint, wherein a spring force may be applied by a spring device to provide for the desired flexing characteristic allowing transverse movements for coupling and decoupling.

For example, the afore-mentioned carrier element may be provided with a release operation member accessible by hand when the attachment plug of the hanger is plugged into the power socket, so as to displace the carrier element against its flexing tension by hand into a decoupling position in which the snap-fit contours of the hair removal device and the hanger are out of engagement. Such release operation member may be a button, or a gripping portion attached to the aforementioned carrier element or support finger so as to allow decoupling or disengagement of the snap-fit contours by means of pressing the attachment plug between two fingers or pressing the gripping member inwardly.

So as to provide for self-explaining operation, such gripping member or push button may be emphasized by shape or surface structure, wherein, for example, an elevated touch surface may be provided and may be marked with, for example, a symbol like an arrow.

According to a further aspect, the hanger may include a soft portion and a hard portion, which both may be made from plastic material. More particularly, the hanger body which may form a loop or a sling or an eyelet and/or may form a gripping portion of the hanger may be made from soft plastic material or rubber-like material, whereas the hanger's plug to be inserted into the power socket of the personal care device may be formed from hard material, in particular hard plastic material. For example, the hanger may be made in one piece by means of a two-component injection molding process. In the alternative, the plug may be assembled from at least two parts that were manufactured separately.

According to a still further aspect, the hanger may be configured to completely close or completely cover the power socket in the housing of the personal care device to help in water-resistance of the personal care device. The hanger's attachment plug may be provided with a water deflector for preventing water from entering into the power socket when the attachment plug is inserted into said power socket. Such water deflector or seal may include a collar-like rim or flexible lip extending beyond the opening edge of the power socket to cover the power socket like an umbrella. The lip may project from a rearward end portion of the attachment plug body neighboring the opening edge of the power socket and projecting over such opening edge to for a sort of ring-shaped umbrella extending over the opening edge of the power socket. The collar-like lip may touch the housing or be pressed against the housing or plug socket surface to achieve better sealing.

In addition, or in the alternative, the hanger's attachment plug may be provided with a sealing layer or a sealing element such as a sealing ring snuggly fitting onto the surface of the power socket and/or the housing of the personal care device to achieve sealing of the power socket vs. the ambience.

According to another aspect, the power socket may be provided with a drainage function to allow water trapped in the interior of the socket due to the inserted attachment plug of the hanger to be drained. More particularly, a through hole through an inner circumferential wall of the socket may form part of a drainage path for draining water from the interior of the power socket to an outer side of the housing. Such through hole may form, at the same time, the undercut or snap-fit contour of the power socket to be latched with the snap-fit contour of the attachment plug of the hanger, thereby providing for a double-function of the snap-fit contour.

In addition or in the alternative, the attachment plug may be provided with a drainage passage for draining water from the interior of the power socket to an outer side of the personal care device or more generally, from a space neighboring a front face of the attachment plug to an outer side of the hanger neighboring a rear portion of the attachment plug, said rear portion being connected to the loop-shaped hanger body.

According to another aspect, a controller for controlling a function of the personal care device may be responsive to short circuiting or contacting of connector pins of the power socket by said attachment plug of said hanger to modify a function of the personal care device upon insertion of the attachment plug of the hanger into the power plug circuit, wherein, more particularly, said controller may be configured to control a display of the personal care device to indicate attachment of the hanger upon detection of short circuiting or contacting of the connector pins by the attachment plug of the hanger.

For example, the attachment plug may be provided with electric contact elements for short-circuiting and/or connecting to the connector pins of the power socket to affect an electric or magnetic property of the connector pins to be detected and processed by the controller to modify a function of the device.

Sliding the attachment plug, with pin receiving recesses, over the receiving connector pins of the power socket also may be used for latching or snap-fitting the attachment plug in the power socket. More particularly, said pin receiving recesses may be provided with a snap-fit contour for snap-fitting the attachment plug onto said connector pins, wherein such connector pins may be provided with a complementary snap-fit contour in terms of, for example, an undercut or a constriction such as for example a neck having a step-like edge.

The housing may have a multi-shell structure comprising an inner housing in which the motor is received, and an outer housing surrounding said inner housing in a shell-like manner. Although the housing includes an outer shell in terms of the aforementioned outer housing surrounding the inner housing, the support structure of the shaver head may be connected directly to the inner housing which supports the motor and the shaft which is connected to the motor and includes a shaft portion extending outside the housing towards the shaver head. Thus, the outer housing may be designed to meet users' tactile preferences without being restricted by the supporting function of the housing.

More particularly, the housing may include an inner housing receiving the motor and an outer housing surrounding said inner housing, wherein said inner housing may be provided with an opening (this opening being open one side only) for a charging connection on an end portion of said inner housing, said opening being provided with said power socket for receiving anyone of an electric power supply plug and said hanger attachment plug.

The inner housing may form a sealed, in particular water-proof container in which the motor, batteries or accumulators or other power sources and an electronic control unit for controlling the motor may be received and protected against liquids and moisture, wherein said container may have a barrel structure and being formed by an elongated pot or cup having a closed bottom and an open top side, wherein the motor, an electronic control unit and batteries may be completely received within such cup element of the inner housing which, at its open top side, may be closed by means of a cover element which may form the front face of the barrel-like container forming the inner housing.

So as to hold the motor and/or the electronic control unit and/or the batteries in position within the inner housing, a support frame to which the aforementioned components are attached, may be inserted into the cup element, and may be held there in place, wherein for example a slideable guide element such as a guiding groove and/or guiding projections may be provided. Such support frame may be formed by or include a circuit board forming part of the electronic control unit. The shaft for driving the cutter unit may be rotatably supported by a bearing or a plurality of bearings attached to and/or formed by the cup element and/or the cover element of the inner housing.

So as to help in sealing the inner housing, the inner housing may have only one opening which may be an opening in the cover element through which the shaft protrudes. Optionally, there may be a second opening in an end portion opposite to the cover element which second opening may be provided for a charging connection. However, such second opening may be avoided by means of integrating the charging connectors into the inner housing, for example by means of molding charging pins to be an integral part of the inner housing.

So as to allow communication with the control unit inside the inner housing, the inner housing may include a soft material portion allowing to be deformed so as to activate switches positioned inside the inner housing. In addition, or in the alternative, the inner housing may be provided with a display means for displaying information such as an indication that the hanger is attached, wherein such display element may be integrated into the inner housing by means of molding and/or form a part of the inner housing's surface.

So as to allow access to the aforementioned soft material portion associated with switching means of the inner housing, the outer housing also may have soft material portions and/or a recess or opening through which the soft material portion of the inner housing can be deformed. In addition, or in the alternative, the outer housing may include a transparent portion covering the aforementioned display means of the inner housing so that such display means is visible through the transparent portion of the outer housing. In the alternative or in addition it also would be possible to provide the outer housing with a recess or opening through which the display can be seen.

The outer housing may have a two-piece or three-piece or multiple-piece shell structure comprising a plurality of shell elements that can be connected with each other and cover different portions of the inner housing. In particular, the outer housing may comprise two shell elements extending on opposite sides of the inner housing and connectable to each other. Such shell elements may have a substantially—roughly speaking—flute-like or chute-like contour so that the two shell elements together may surround the inner housing substantially completely.

These and other features become more apparent from the examples shown in the drawings.

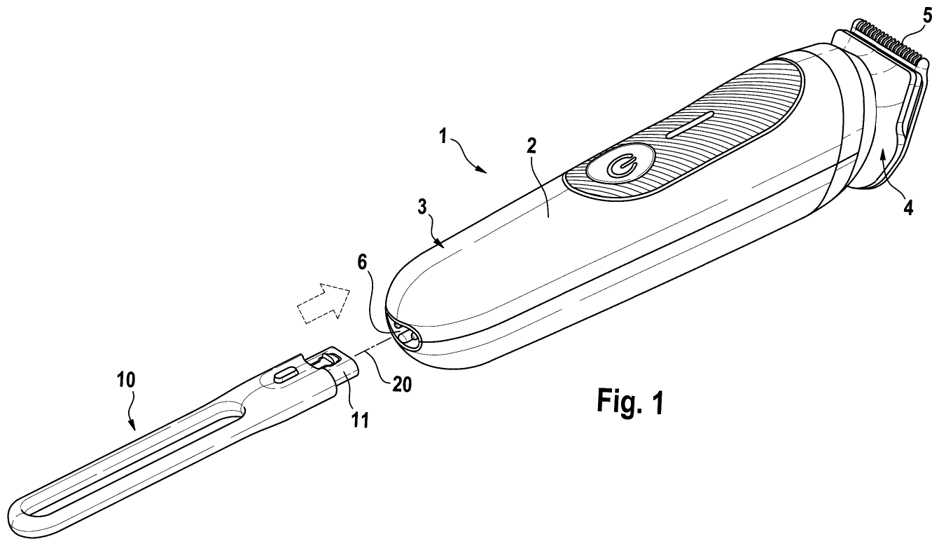

As can be seen from FIG. 1, a hair removal device, trimmer or shaver 1 may have a housing 3 forming a handle 2 for holding the hair removal device, which handle may have different shapes such as—roughly speaking—a substantially cylindrical shape or box shape or bone shape allowing for ergonomically grabbing or holding the hair removal device, wherein such handle 2 has a longitudinal axis 20 due to the elongated shape of the handle, cf. FIG. 1.

More particularly, the handle 2 may have a cross-sectional shape which is rounded or circular or oval or elliptical, wherein mixtures of those shapes are possible. Irresectable of the cross-sectional shape, the cross-section may continuously increase from one end of the handle to the other one thereof.

On one end of the handle 2, a working head 4 is attached to the handle 2, wherein the working head 4 may be slewably supported about one or more axes substantially perpendicular to the aforementioned longitudinal handle axis 20.

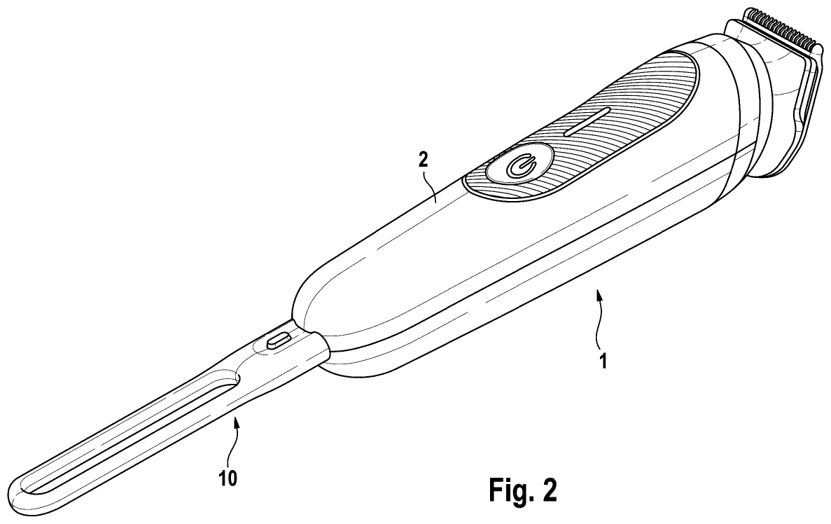

The working head 4 may include different kinds of cutter units 5 such as cooperating blades of a trimmer unit, cf. FIGS. 1 and 2.

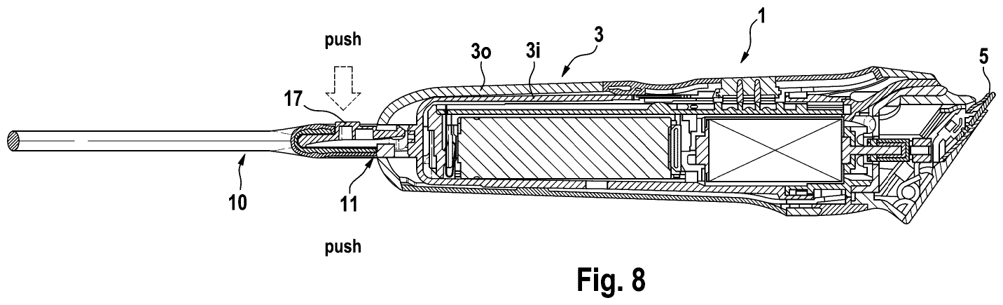

As can be seen from FIG. 8, the housing 3 forming the handle 2 may have a two-shell structure comprising an inner housing 3i and an outer housing 3o (this reference numeral reads “3o” with an “o” for outer”) surrounding said inner housing 3i.

The inner housing 3i accommodates the aforementioned motor 9 and furthermore, an electrical storage such as batteries or an accumulator, and an electronic control unit, cf. FIG. 8, wherein the inner housing 3i may form a water-tight container protecting such components from liquids and moisture.

More particularly, the inner housing 3i may have an elongated barrel-like structure including a cup-shaped or pot-like base element 30 having a closed bottom and an open top face, wherein such base element may extend substantially over the entire length of the handle 2, cf. FIG. 8.

As can be seen from FIGS. 8, 13 and 14, charging connections such as charging pins 31 may protrude from the bottom side of the inner housing 3i so as to allow charging of the batteries inside the inner housing 3i. Said charging pins 31 may form part of or be positioned in the interior of a power socket 6 which basically may form a recess in the bottom end of the housing 3.

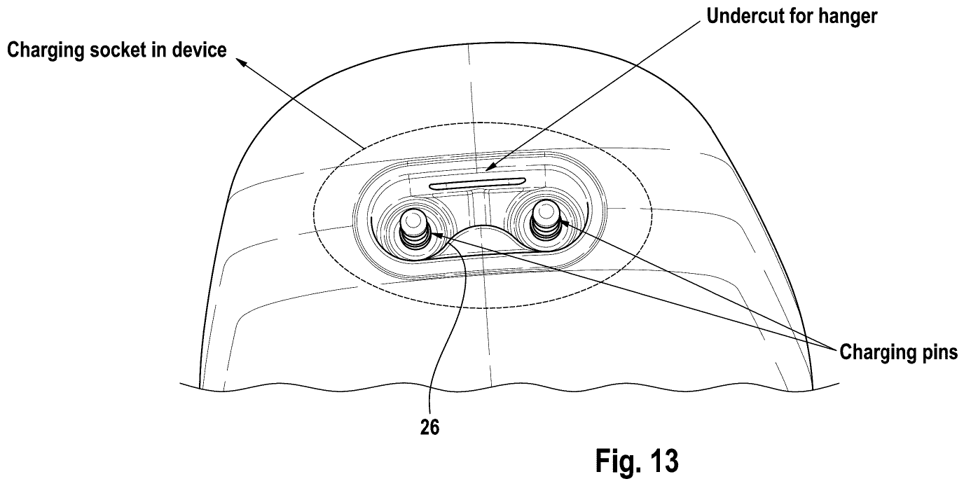

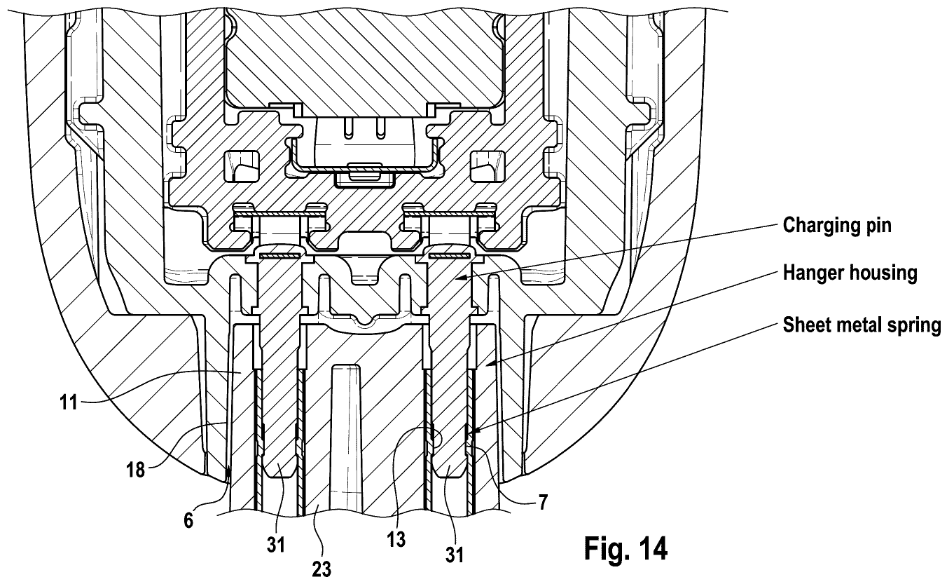

More particularly, the power socket 6 may be attached to or formed by an end portion of the inner housing 3i, wherein the power socket 6 may form a cup-shaped or bowl-shaped neck portion or stub portion which is closed towards the interior of the inner housing 3i by means of a bottom of the neck portion or stub portion and, on the other hand, open towards the exterior side. A circumferential wall 18 defines, together with said bottom, the interior of the power socket 6 in which interior connection pins or charger pins 31 are accommodated, cf, FIGS. 13 and 14. Only the charging pins 31 extend through the shell structure of the inner housing, wherein such charging pins 31 may be sealed against the inner housing 3i to prevent water from entering into the interior.

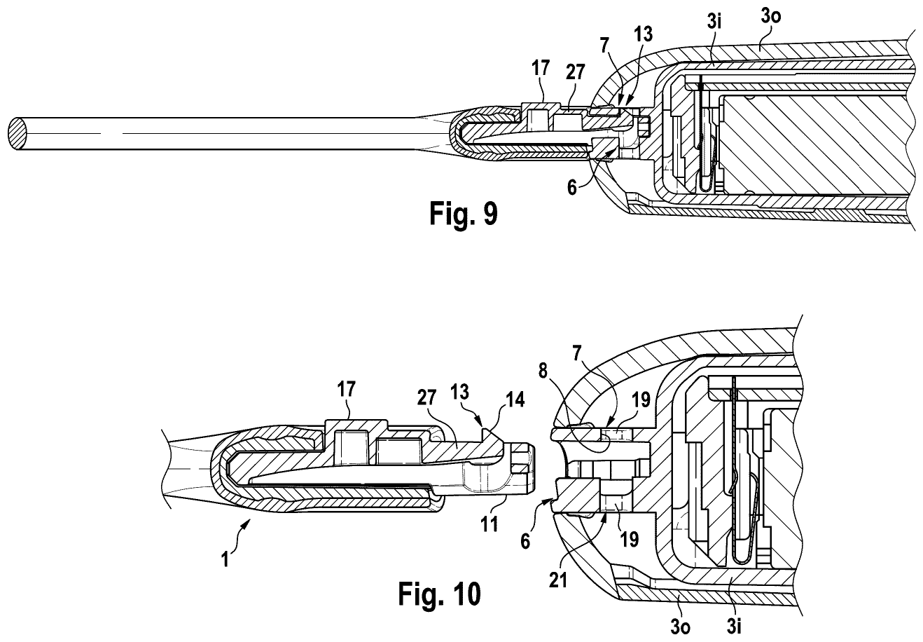

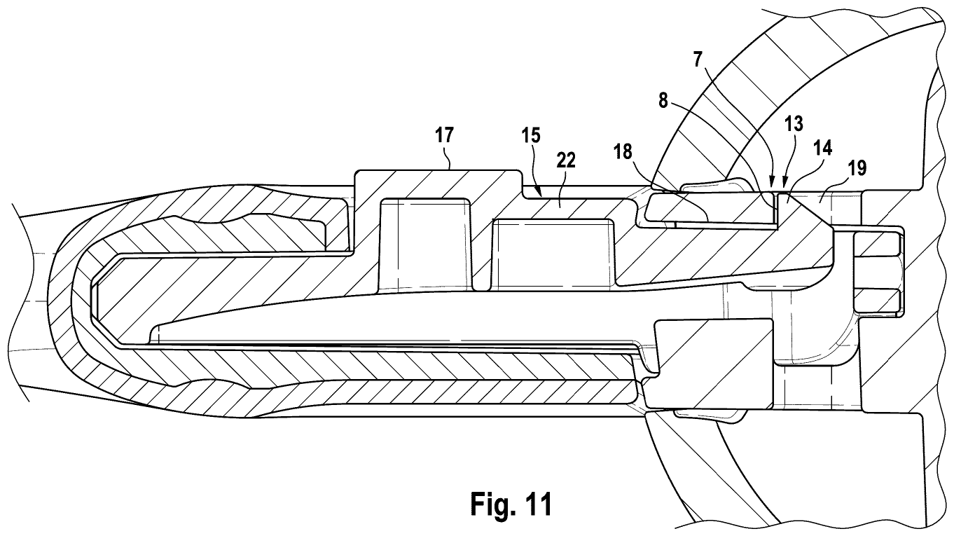

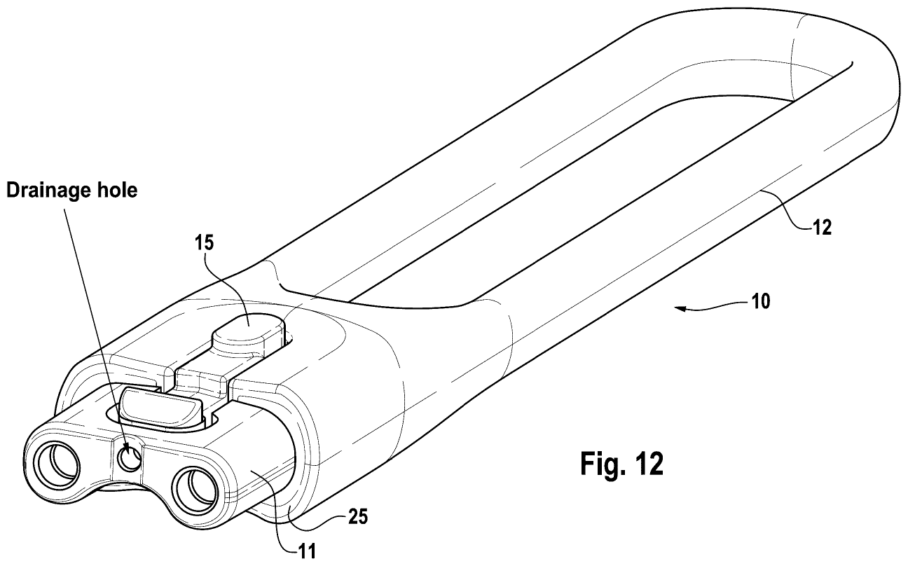

As can be seen from FIGS. 9 and 10, the power socket 6 may be substantially flush with the outer surface of the outer housing 30 which may surround or encompass the open end portion of the power socket 6, cf. FIGS. 10 and 14. The power socket 6 may be seated in an opening of the outer housing 30 with some play therebetween or may be slightly press-fitted thereto.

The outer housing 30 may have a shell structure including a pair of elongated shell elements which together may surround the inner housing 3i substantially entirely and may be connected to each other so that they together form the gripping surface of the substantially cone-shaped or cylindrical handle 2.

As may be best seen from FIG. 10 and FIG. 13, the power socket 6 may be provided with a snap fit contour 7 which may be positioned at the inner circumferential side of the power socket 6.

More particularly, such snap fit contour 7 may be formed by a recess in the circumferential wall defining the insertion opening of the power socket.

The power socket may have an elongated and/or flattened cross-sectional contour, for example an oval-like contour, cf. FIG. 13. So as to achieve a well-fit coupling, the snap fit contour may be provided in one of the longer sides of such elongated cross-sectional contour, cf. FIG. 13.

So as to prevent the attachment plug 11 of hanger 10 from being inserted in a wrong orientation, the cross-sectional contour of the power socket 6 and corresponding thereto, the cross-sectional contour of the attachment plug 11, may have a rotatorily asymmetrical shape. For example, on a side opposite to the snap fit contour 7, a projecting rib 26 may be provided to allow for insertion of the attachment plug 11 of hanger 10 only when a side having a concave recess may pass over the projecting rib 26.

The aforementioned snap fit contour 7 may include an undercut 8 that may be formed by a recess in the transverse direction. As can be seen from FIGS. 9 and 10, the attachment plug 11 of hanger 10 may be inserted into the power socket 6 along an insertion axis that is basically defined by the coaxially arranged longitudinally access 20 of both the attachment plug 11 and the power socket 6. The recess forming the undercut 8 extends transverse to such longitudinal axis 20 and widens the inner contour of the power socket 6 at a circumferential side thereof.

Such recess forming the undercut 8 may be a through hole 19 going through the inner circumferential wall 18 of the inner housing 3i so as to provide for a drainage path for draining water from the interior side of the power socket 6 towards an outer side of inner housing 3i. More particularly, water may be drained through such through hole 19 into a gap or interspace between the outer housing 30 and the inner housing 3i. As the outer housing 30 may surround the power socket 6 with a gap therebetween, water may further drain to the outside of the exterior housing 30.

The snap fit contour 7 may define a step-like contour edge, wherein such edge may be angled, for example, under an angle ranging from 70° to 120° or may be about 90°, cf. FIG. 10. Alternative to such more or less sharp edge, a rounded edge is possible, so as to, for example, make decoupling easier, depending on the pre-tension of the snap-fi contours into their engaging position.

The attachment plug 11 of hanger 10 may have a shape substantially complementary to the receiving recess of the power socket 6. More particularly, the attachment plug 11 of hanger 10 may have an elongated cross-sectional contour substantially corresponding to the cross-sectional contour of the inner side of the power socket 6.

On a circumferential side, the attachment plug 11 may be provided with a snap fit contour 13 which may be formed by a hook-shaped or latching projection 14, cf. FIG. 10, wherein such projection 14 may snap fit into the undercut 8. More particularly, the projection 14 of attachment plug 11 may snap fit into through hole 19, when the attachment plug 11 is fully inserted into the power socket 6.

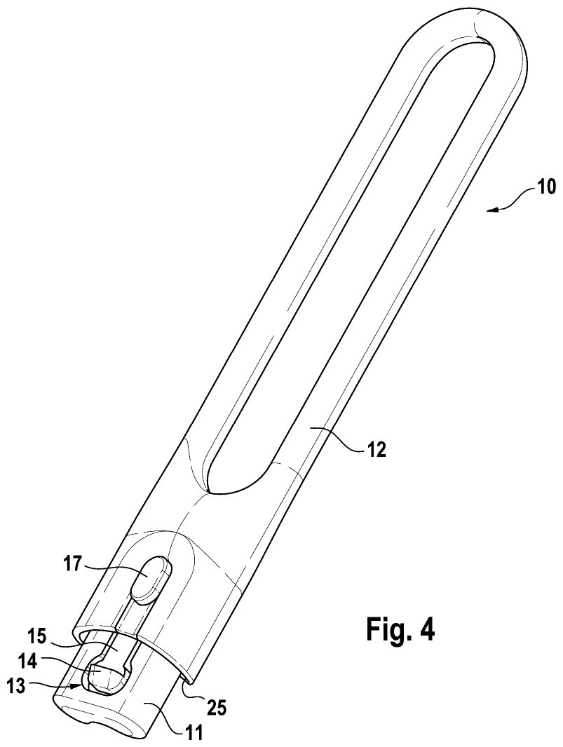

As can be seen from FIGS. 4, 6 and 7, the snap fit contour 13 of the attachment plug 11 may be supported on a carrier element 15 that may be flexibly displaced inwardly and outwardly and in particular in the radial direction so as to allow engaging the undercut 8 and disengaging therefrom.

More particularly, the carrier element 15 may include a support finger 27 which extends substantially parallel to the longitudinal axis 20 of the attachment plug 11 on an outer circumferential side thereof. The support finger 27 may be an integral part of the outer wall of the attachment plug 11 but may be separated from neighboring outer wall portions through a U-shaped slot, cf. FIG. 4 so that the support finger 27 forms a sort of cantilevered bending beam which, at its free end portion supports the snap fit contour 13.

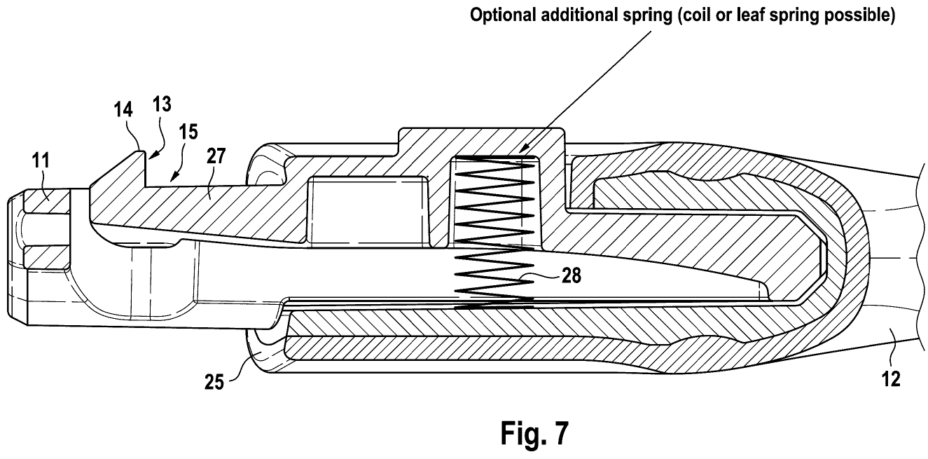

The support finger 27 may be flexible to allow for bending inwardly and outwardly. As shown by FIG. 7, an additional support spring 28 may additionally support the support finger 27 and may apply outwardly directed spring forces thereto to achieve a sort of pretensioning towards the locking position of the snap fit contour 13.

When using such support spring 28, the support finger 27 may be connected to the body of the attachment plug 11 by means of a pivot joint and may be substantially rigid, since flexible displacement inwardly and outwardly may be achieved through pivoting against the spring forces of support spring 28. Such support spring 28 may be a coil spring as shown, wherein, however other spring elements such as a leaf spring or disc springs could be provided.

As can be seen from FIG. 14, the attachment plug 11 may include pin receiving recesses 22 in which the charging pings 31 of power socket 6 may be received when the attachment plug is inserted into the power socket 6.

Such pin receiving recesses 22 also may be provided—in addition or in alternative to the aforementioned snap fit contour on the support finger 27—with a snap fit contour 13 to snap fit to the charging pings 31 which also may be provided with complementary snap fit contours.

For example, the pin receiving recesses 22 may be provided with one or more snap fit projections 14 that may project inwardly and may have a hook-shaped or latching contour. For example, one or more support fingers similar to the ones described before may be provided at the inner walls of the pin receiving recesses 22 with the snap fit protections 14 projecting from such support fingers 27 inwardly.

On the other hand, the charging pins 31 may be provided with snap fit contours 7 in terms of an undercut. For example, the snap fit contours 7 may be formed by a step-like restriction of the diameter of the charging pins 31 or the charging pins 31 may be formed with a thickened end portion or a mushroom head providing for an undercut latching with the projections on the inner sides of the pin receiving recesses 22.

In addition to or in the alternative to latching the pin receiving recesses 22 with the charging pins 31, the pin receiving recesses 22 may be used for changing electrical and/or magnetic characteristics of the charging pins 31. For example, pin receiving recesses 22 may be short circuiting the charging pins 31, wherein, for example, a bridge-like connection that is electrically conductive, may be integrated into the attachment plug 11 to short circuit the charging pins 31.

A detector or detecting circuit which may form part of a controller of the hair removal device 1 may detect such short circuiting or other changes of the electrical or magnetic characteristics of the charging pins 31 to detect insertion of the attachment plug 11 of hanger 10. For example, the controller may instruct a display of the hair removal device 1 to display an indication that the hanger is attached.

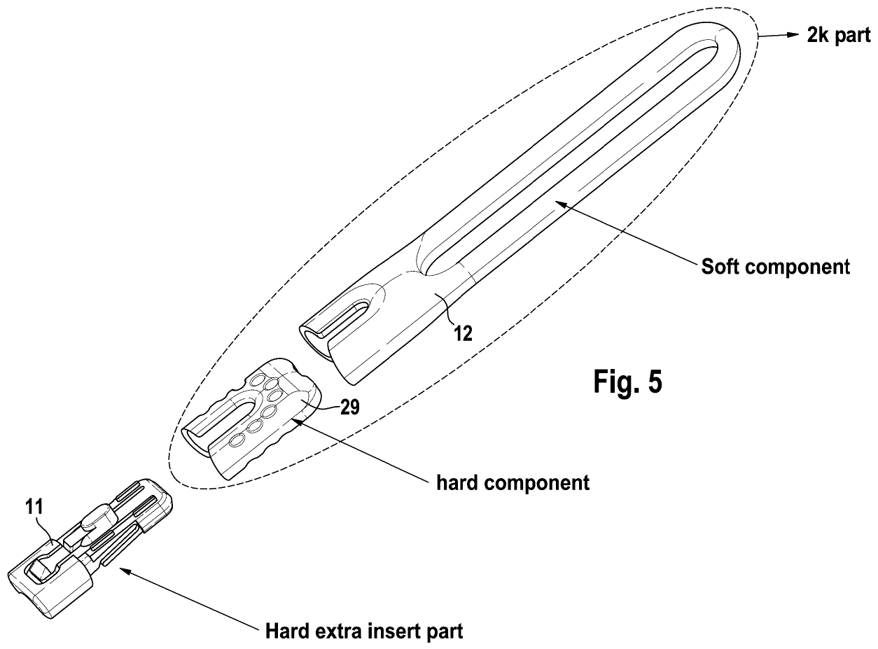

When comparing FIGS. 4 and 5, it becomes clear that the hanger 10 may complies soft components and hard components. For example, the attachment plug 11 may be formed from a hard material such as hard plastic, whereas on the other hand a body 12 of hanger 10 may be formed from soft material such as soft plastic or a rubber-like material. For example, the hanger 10 may be formed by an injection molding process using different types of melt plastic for forming the different components, wherein the soft and hard components may be joint integrally to each other by means of such injection molding process.

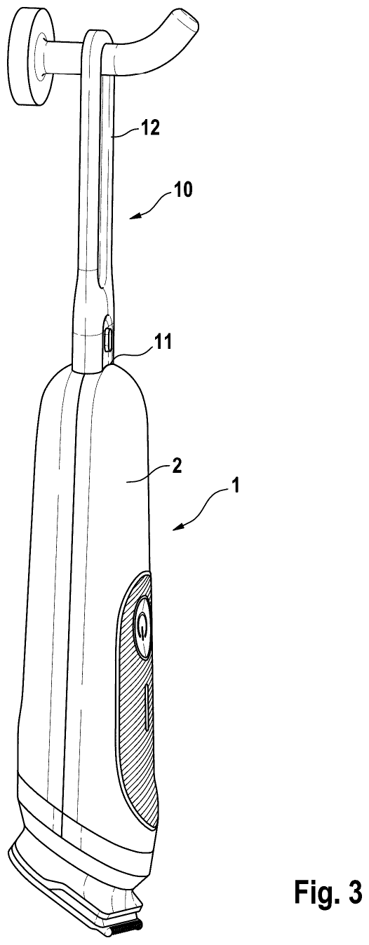

More particularly, the body 12 may have a loop shape or may include a loop-shaped portion or may include an eyelet to allow for hanging the hanger 10 onto a wall pin extending from a, for example, shower cabin wall, cf. FIG. 3.

The attachment plug 11 may be attached to one end of the elongated body 12, wherein the elongated body 12 may have, at one end, a receiving recess in which the attachment plug 11 may be received. As shown by FIG. 5, the attachment plug 11 itself may form a separate insert part that may be connected to the body 12 via a sort of adapter part 29 or connection part 29 which may be formed from hard material such as hard plastic. The adapter part 29 is directly connected to the body 12, whereas on the other hand the attachment plug 11 may be connected to said adapter or intermediate part 29, cf. FIG. 5.

As can be seen from FIGS. 1, 2 and 3, the hanger 10 may have a length comparable to the length of the handle 2 of the hair removal device 1. For example, the hanger length may range from 50% to 150% or 50% to 90% of the handle length. Irrespective of such length, the hanger 10, more particularly its body portion 12, may have a width that is smaller than the diameter of the handle 2. For example, the width of the body 12 of the hanger 10 may range from 50% to 90% of the sickness of the handle 2.

For example, the loop-shaped hanger body may have a length ranging from 3 cm to 15 cm or 4 cm to 10 cm, and an inner width of the loop ranging from 0.5 cm to 3 cm or 0.7 cm to 1.5 cm to have a good compromise between compact design for easy gripping and sufficient size for easily hooking the hanger 10 onto a wall pin.

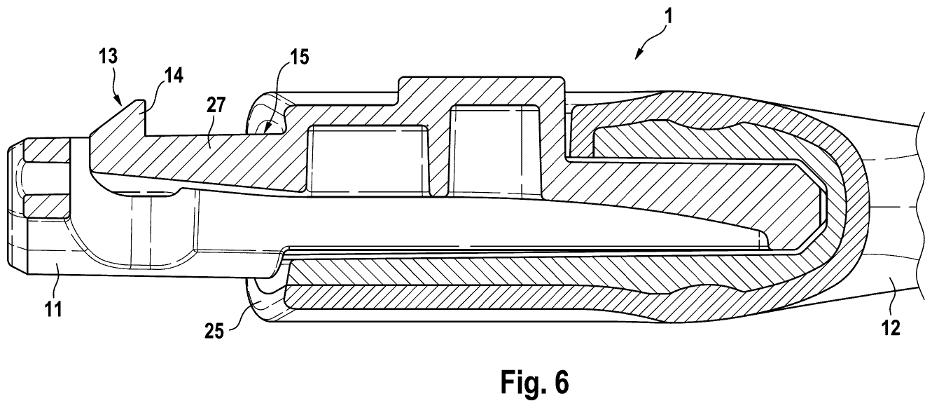

As can be seen from FIGS. 6 and 7, the soft material body 12 may form a collar-like projection surrounding a rearward end portion of the attachment plug 11, wherein, when inserted into the power socket 6, such soft material collar 25 may abut against the axial end portion of outer housing 30 and/or may cover the open end portion of the power socket 6 to prevent water from entering into the power socket 6.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. System comprising a personal care device, in particular electric hair removal device, and a hanger, said hanger being provided with an attachment plug and a loop portion, said personal care device being provided with an elongated housing receiving an electric motor and/or an electric power source, a working head attached to said housing, wherein a power socket for receiving an electric power supply plug is provided at said housing, wherein said power socket is provided with a snap-fit contour for snap-fitting said attachment plug in the power socket, wherein said attachment plug is made from hard material, in particular hard plastic material and said loop portion which is made from soft material, in particular soft plastic material.

2. System according to claim 1, wherein said snap fit contour is formed by an undercut at an inner circumferential wall of the power socket.

3. System according to claim 2, wherein said undercut is formed by a through hole through said inner circumferential wall, preferably wherein said through hole is part of a drainage path for draining water from the interior of the power socket to an outer side of the housing.

4. System according to claim 1, wherein a controller for controlling a function of the personal care device is responsive to short circuiting or contacting of connector pins of the power socket by said attachment plug of said hanger to modify a function of the personal care device upon insertion of the attachment plug of the hanger into the power socket, wherein, more particularly, said controller is configured to control a display of the personal care device to indicate attachment of the hanger upon detection of short circuiting or contacting of the connector pins by the attachment plug of the hanger.

5. System as defined in claim 1, wherein said housing includes an inner housing receiving said motor and an outer housing surrounding said inner housing, wherein said inner housing is provided with an opening for a charging connection on an end portion of said inner housing, said opening being provided with said power socket for receiving anyone of an electric power supply plug and said hanger attachment plug.

6. Hanger for hanging up a personal care device, in particular an electric hair removal device, said hanger comprising an attachment plug to be inserted into the power socket of said personal care device, wherein said attachment plug is provided with a snap-fit contour for snap-fitting the attachment plug in the power socket of the personal care device, wherein said attachment plug is made from hard material, in particular hard plastic material, and further comprising a hanger body forming a gripping portion and/or loop portion which is made from soft material, in particular soft plastic material.

7. Hanger according to claim 6, wherein said snap-fit contour of the attachment plug includes a projection matching with an undercut in an interior circumferential wall of the power socket for snap-fitting therewith, said projection projecting from an outer circumferential side of the attachment plug in a direction transverse to a longitudinal axis of the attachment plug defining the axis of insertion of the attachment plug into the power socket.

8. Hanger according to claim 6, wherein said snap-fit contour is provided on a flexible or flexibly supported carrier element which is flexibly displaceable in a direction transverse to the axis of insertion of the attachment plug of the hanger into the power socket of the personal care device.

9. Hanger or system according to claim 8, wherein said carrier element is provided with a release operation member accessible by hand when the attachment plug of the hanger is plugged into the power socket to displace the carrier element by hand into a decoupling position in which the snap-fit contours of the hair removal device and the hanger are out of engagement.

10. Hanger according to claim 6, wherein the attachment plug is occupying the substantially entire cross-sectional area of the power socket when inserted into said power socket and/or is self-locking in the power socket without any additional elements inserted into said power socket.

11. Hanger according to claim 6, wherein said hanger further comprising a hanger body forming a gripping portion and said loop portion which are both made from soft material, in particular soft plastic material,

12. Hanger according to claim 6, wherein said attachment plug and said body portion are formed as an integral, one-piece injection molding part and wherein optionally said attachment plug is made by a further hard plastic part assembled to the one-piece injection molding part.

13. Hanger according to claim 6, wherein said attachment plug is provided with a drainage passage for draining water from the interior of the power socket to an outer side of the personal care device or from a space neighboring a front face of the attachment plug to an outer side of the hanger neighboring a rear face side of the attachment plug.

14. Hanger according to claim 6, wherein said attachment plug is provided with pin receiving recesses for receiving connector pins of the power socket, wherein said pin receiving recesses are provided with said snap-fit contour for snap-fitting the attachment plug onto said connector pins.

15. Hanger according to claim 6, wherein said attachment plug is provided with electric contact elements for short-circuiting and/or connecting connector pins of the power socket.

16. Hanger according to claim 6, wherein said attachment plug is provided with a water deflector or sealing element for preventing water from entering into the power socket when the attachment plug is inserted into said power socket and wherein preferably said water deflector element comprises a flexible, collar-shaped lip projecting from a body portion of said attachment plug outwardly to neighbor and cover an opening edge of said power socket.
